(19) United States
(12) Patent Application Publication
(10) Pub. No.: US 2021/0356773 A1
(43) Pub. Date: Nov. 18, 2021

(54) COLOR FILTER SUBSTRATE AND DISPLAY APPARATUS

(71) Applicants: FUZHOU BOE OPTOELECTRONICS TECHNOLOGY CO., LTD., Fujian (CN); BOE TECHNOLOGY GROUP CO., LTD., Beijing (CN)

(72) Inventors: Weihuan Guo, Beijing (CN); Lifeng Lin, Beijing (CN); Tao Fang, Beijing (CN); Cong Song, Beijing (CN)

(21) Appl. No.: 16/332,267

(22) PCT Filed: Aug. 10, 2018
(86) PCT No.: PCT/CN2018/099957

§ 371 Date: Mar. 11, 2019

(30) Foreign Application Priority Data
Nov. 15, 2017 (CN) 201711135082.0

(51) Int. Cl. G02F 1/01; G02F 1/1335

(52) U.S. Cl. CPC G02F 1/0126; G02F 1/133514; G02F 2202/14; G02F 2201/16; G02F 1/133512

(57) ABSTRACT

There are provided a color filter substrate and a display apparatus. The color filter substrate comprises a base substrate; a black matrix; a first color filter; a planarization layer, which is located between the base substrate and the black matrix and has an opening; and a first color cast compensation layer, which is located in the opening of the planarization layer, wherein a light of a first color passes through the first color filter in a direction deviating from the vertical direction of the base substrate at an angle a, the first color cast compensation layer at least partly converts the light of the first color passing through the first color filter to a light of a second color or a light of a third color, and the angle a is greater than or equal to 0 degree and less than 90 degrees.

### CROSS-REFERENCE TO RELATED APPLICATION

This disclosure claims the priority of Chinese Patent Application No. 201711135082.0 filed on Nov. 15, 2017, which is incorporated herein by reference in its entirety.

### TECHNICAL FIELD

This disclosure relates to the field of display. Particularly, this disclosure relates to a color filter substrate and a display apparatus.

### BACKGROUND ART

In a display product comprising a color filter substrate having three color filters, there is typically a problem of color cast at left and right view angles. For example, in a display product comprising a color filter substrate having RGB color filters, there is typically a problem of red color cast at left and right view angles.

### SUMMARY OF THE INVENTION

In one aspect, this disclosure provides a color filter substrate, comprising:

a base substrate,

a black matrix, which comprises a plurality of first black matrix lines along a first direction and a plurality of second black matrix lines along a second direction, wherein the plurality of first black matrix lines and the plurality of second black matrix lines are staggered to constitute a plurality of grid regions arranged in a matrix form, and wherein the plurality of grid regions comprise at least a first grid region;

a first color filter, which is located in the first grid region;

a planarization layer, which is located between the base substrate and the black matrix and has an opening; and

a first color cast compensation layer, which is located in the opening of the planarization layer, wherein a light of a first color passes through the first color filter in a direction deviating from the vertical direction of the base substrate at an angle α, the first color cast compensation layer at least partly converts the light of the first color passing through the first color filter to a light of a second color or a light of a third color, and wherein the light of the first color has a wavelength longer than that of the light of the second color, the light of the second color has a wavelength longer than that of the light of the third color, and the angle α is greater than or equal to 0 degree and less than 90 degrees.

In one embodiment, the opening is in one-to-one correspondence with the first color filter; an orthographic projection of the first color cast compensation layer on the base substrate covers an orthographic projection of the first color filter on the base substrate; and orthographic projections of the first grid region and two first black matrix lines and two second black matrix lines constituting the first grid region on the base substrate cover an orthographic projection of the first color cast compensation layer on the base substrate.

In another embodiment, the first color cast compensation layer has a thickness of 1 mm to 5 mm.

In another embodiment, the color filter substrate further comprises a second color filter and a third color filter, wherein the plurality of grid regions further comprise a second grid region and a third grid region, and the second color filter is located in the second grid region and the third color filter is located in the third grid region; and

the opening is in one-to-one correspondence with the second black matrix line adjacent to one color filter selected from the first color filter, the second color filter, and the third color filter, and an orthographic projection of the first color cast compensation layer on the base substrate is covered by an orthographic projection of the second black matrix line, which is adjacent to one color filter selected from the first color filter, the second color filter, and the third color filter, on the base substrate.

In another embodiment, the first color cast compensation layer comprises an isotropic photochromic material, wherein the isotropic photochromic material is excited by a light of a first color to generate a photochromic effect, and the light of the first color is converted to a light of a second color or a light of a third color after passing through the isotropic photochromic material.

In another embodiment, the isotropic photochromic material comprises MoO₃.

In another embodiment, the first color cast compensation layer comprises an anisotropic photochromic material, wherein the light of the second color or the light of the third color converted from the light of the first color by the anisotropic photochromic material increases as the angle α increases.

In another embodiment, the anisotropic photochromic material is selected from the group consisting of diarylethylene, pyrryl fulgide, or a mixture thereof.

In another embodiment, the distance between an orthographic projection of the first color cast compensation layer on the base substrate and an orthographic projection of one color filter selected from the first color filter, the second color filter, and the third color filter on the base substrate is greater than 7 μm.

In another embodiment, a length of the opening along a row direction is greater than or equal to a length of the first color filter along a row direction.

In another embodiment, the opening is a wedge opening toward the second black matrix line, and the wedge opening has a bottom width of 10 μm or more and an opening width of 15 μm or more.

In another embodiment, the color filter substrate further comprises a first insulating layer located between the first color filter and the first color cast compensation layer, wherein the first insulating layer has a thickness of 0.4 μm to 1.0 μm.

In another embodiment, the planarization layer has a thickness of 1 mm to 5 mm.

In another embodiment, the color filter substrate further comprises a second insulating layer located between the base substrate and the first color cast compensation layer, wherein the second insulating layer has a thickness of 0.4 μm to 1.0 μm.

In another aspect, this disclosure provides a display apparatus, comprising the color filter substrate according to any one described above.

### DESCRIPTION OF DRAWINGS

In order to illustrate the technical solutions in Examples of this disclosure more clearly, figures required for describing the Examples will be simply introduced below. It is apparent that the figures described below are merely exemplary Examples of this disclosure, and other figures may be further obtained by those of ordinary skill in the art according to these figures without exerting inventive work.

FIG. 1 is a partial schematic diagram exemplarily representing a black matrix.

FIG. 2 is a sectional schematic diagram exemplarily representing a display apparatus after cell-aligning of a color filter substrate according to an Example of this disclosure and a thin-film transistor.

FIG. 3 is a perspective schematic diagram exemplarily representing relationships of positions and sizes of a first black matrix line and a second black matrix line of a black matrix, a red color filter, and a red color cast compensation layer of a color filter substrate as shown in FIG. 2.

FIG. 4 is a sectional schematic diagram of a display apparatus after cell-aligning of a color filter substrate according to another Example of this disclosure and a thin-film transistor.

FIG. 5 is a sectional schematic diagram of a display apparatus after cell-aligning of a color filter substrate according to still another Example of this disclosure and a thin-film transistor.

FIG. 6 is a sectional schematic diagram of a display apparatus after cell-aligning of a color filter substrate according to yet another Example of this disclosure and a thin-film transistor.

### DESCRIPTION OF EMBODIMENTS

The technical solutions in the Examples of this disclosure will be described clearly and fully below in conjunction with specific embodiments of this disclosure. Obviously, the embodiments and/or Examples described are merely a part of the embodiments and/or Examples of this disclosure, rather than all of the embodiments and/or Examples. Based on the embodiments and/or Examples of this disclosure, all other embodiments and/or Examples obtained by those of ordinary skill in the art without performing inventive work belong to the scope protected by this disclosure.

In the description below, a color filter substrate comprising a red (R) color filter, a green (G) color filter, and a blue (B) color filter is exemplified for illustration. That is, the first color may be red, the second color may be green, and the third color may be blue. The light of the first color may be red light, the light of the second color may be green light, and the light of the third color may be blue light. However, this disclosure is not limited thereto. For example, other color mixing schemes, such as RGBY (red/green/blue/yellow), RGBW (red/green/blue/white), and the like, may also exist. The technical solutions of this disclosure may be used in other color mixing schemes by those skilled in the art without exerting inventive work, and these all belongs to the scope protected by this disclosure.

In this disclosure, the layer and the film may be interchangeably used, unless specifically indicated. In this disclosure, all characteristics of numeric values mean to be within an error range of measurement, for example within ±10%, within ±5%, or within ±1% of a defined numeric value. Terms “first”, “second”, “third”, and the like are for the purpose of description only, and cannot be understood as indicating or suggesting relative importance or implying the number of technical features indicated. Thereby, a characteristic defined by “first”, “second”, “third”, and the like may expressly or impliedly comprises one or more characteristics. In this disclosure, “on” in terms “formed on” or “coated or deposited on” may comprise “on the whole surface” or “on a part of the surface”. In this disclosure, an opening may include a hole.

In one aspect of this disclosure, there may be provided a color filter substrate, comprising:

a base substrate,

a black matrix, which comprises a plurality of first black matrix lines along a first direction and a plurality of second black matrix lines along a second direction, wherein the plurality of first black matrix lines and the plurality of second black matrix lines are staggered to constitute a plurality of grid regions arranged in a matrix form, and wherein the plurality of grid regions comprise at least a first grid region, and wherein the first direction and the second direction are different;

a first color filter, which is located in the first grid region;

a planarization layer, which is located between the base substrate and the black matrix and has an opening; and

a first color cast compensation layer, which is located in the opening of the planarization layer, wherein a light of a first color passes through the first color filter in a direction deviating from the vertical direction of the base substrate at an angle α, the first color cast compensation layer at least partly converts the light of the first color passing through the first color filter to a light of a second color or a light of a third color, and wherein the light of the first color has a wavelength longer than that of the light of the second color, the light of the second color has a wavelength longer than that of the light of the third color, and the angle α is greater than or equal to 0 degree and less than 90 degrees.

FIG. 1 is a partial schematic diagram exemplarily representing a black matrix.

As shown in FIG. 1, a black matrix BM comprises a plurality of first black matrix lines BM1 along a first direction and a plurality of second black matrix lines BM2 along a second direction. A plurality of first black matrix lines BM1 and a plurality of second black matrix lines BM2 are staggered to constitute a plurality of grid regions arranged in a matrix form. The plurality of grid regions comprises a first grid region GR1, a second grid region GR2, and a third grid region GR3. The first direction and the second direction are different directions. Exemplarily, the first direction may be a line direction, and the second direction may be a row direction. In this application, illustration is made by taking an example wherein the first direction and the second direction are a line direction and a row direction, respectively.

It is to be noted that “on” and “under” are relative in the accompanying drawings below. For example, a planarization layer is formed on a base substrate, with respect to a color filter substrate, according to process steps. In the figure, however, the emergence direction of light is allowed to face upward for convenience, and therefore it is shown that a base substrate is on a planarization layer. Therefore, the opening faces downward in the figure.

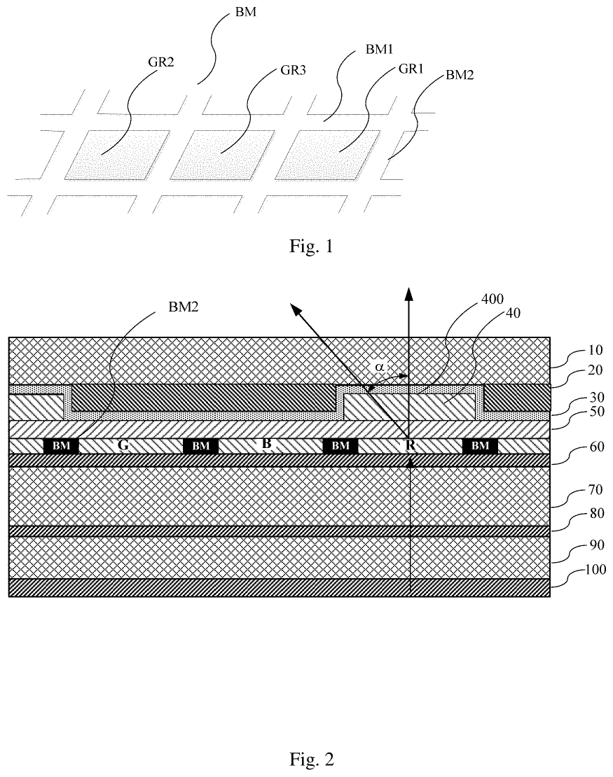

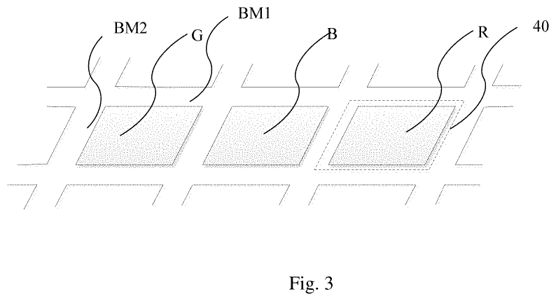

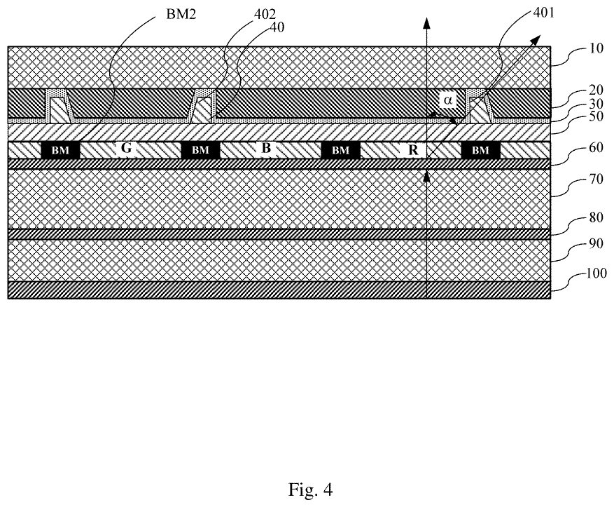

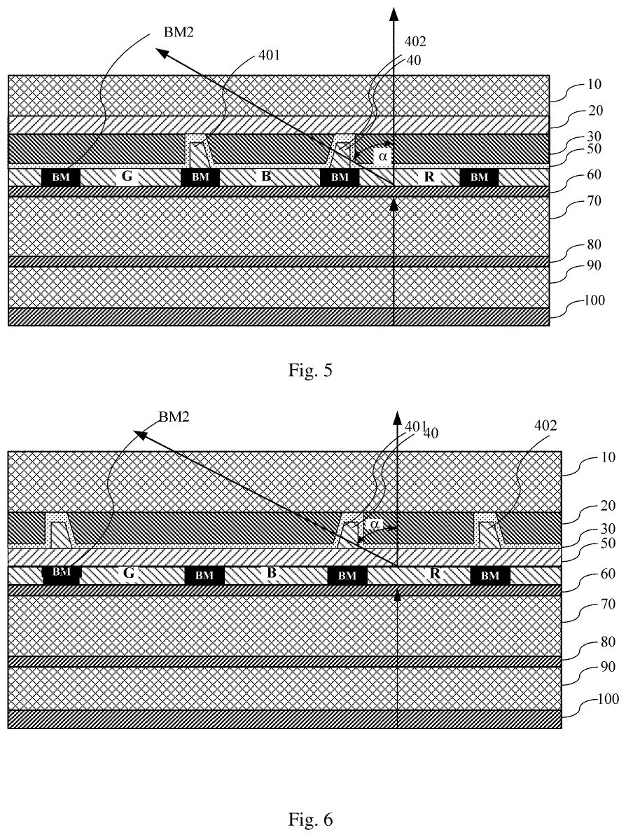

FIG. 2 is a sectional schematic diagram exemplarily representing a display apparatus after cell-aligning of a color filter substrate according to an Example of this disclosure and a thin-film transistor, wherein the orthographic projection of the red color cast compensation layer on the base substrate may cover the orthographic projection of the red color filter on the base substrate; and the orthographic projections of the first grid region and two first black matrix lines and two second black matrix lines constituting the first grid region on the base substrate cover the orthographic projection of the red color cast compensation layer on the base substrate. FIG. 3 is a perspective schematic diagram exemplarily representing relationships of positions and sizes of a first black matrix line and a second black matrix line of a black matrix, a red color filter, and a red color cast compensation layer of a color filter substrate as shown in FIG. 2. FIG. 4 is a sectional schematic diagram of a display apparatus after cell-aligning of a color filter substrate according to another Example of this disclosure and a thin-film transistor, wherein the opening is in one-to-one correspondence with the second black matrix line adjacent to the green color filter, and the orthographic projection of the red color cast compensation layer on the base substrate is covered by the orthographic projection of the second black matrix line, adjacent to the green color filter, on the base substrate. FIG. 5 is a sectional schematic diagram of a display apparatus after cell-aligning of a color filter substrate according to still another Example of this disclosure and a thin-film transistor, wherein the opening is in one-to-one correspondence with the second black matrix line adjacent to the blue color filter, and the orthographic projection of the red color cast compensation layer on the base substrate is covered by the orthographic projection of the second black matrix line, adjacent to the blue color filter, on the base substrate. FIG. 6 is a sectional schematic diagram of a display apparatus after cell-aligning of a color filter substrate according to yet another Example of this disclosure and a thin-film transistor, wherein the opening is in one-to-one correspondence with the second black matrix line adjacent to the red color filter, and the orthographic projection of the red color cast compensation layer on the base substrate is covered by the orthographic projection of the second black matrix line, adjacent to the red color filter, on the base substrate.

As shown in FIGS. 2 and 4 to 6, the color filter substrate according to an Example of this disclosure may comprise: a base substrate 10, a planarization layer 20, and a black matrix BM comprising a second black matrix line BM2. The planarization layer 20 is located between the black matrix BM and the base substrate 10. The color filter substrate may further comprise: a red color filter R, a green color filter G, and a blue color filter B. The red color filter R is located in the first grid region GR1 of FIG. 1. The green color filter G is located in the second grid region GR2 of FIG. 1. The blue color filter B is located in the third grid region GR3 of FIG. 1.

An opening 400 (FIG. 3), 401 (FIGS. 4 to 6), or 402 (FIGS. 4 to 6) is formed in the planarization layer 20. The red color cast compensation layer 40 is located in the opening of the planarization layer 20. Red light may pass through the red color filter R in a direction deviating from the vertical direction of the base substrate 10 at an angle α. The red color cast compensation layer 40 may at least partly convert red light passing through the red color filter R to green light or blue light. The angle α may be greater than or equal to 0 degree and less than 90 degrees.

The color filter substrate according to an embodiment of this disclosure may further comprise: a first insulating layer 50 located between the red color filter R and the red color cast compensation layer 40. The color filter substrate according to an embodiment of this disclosure may further comprise a second insulating layer 30. The second insulating layer 30 is formed on the first insulating layer 50 and the red color cast compensation layer 40, and the part covering the red color cast compensation layer 40 is filled in the bottom of the opening of the planarization layer 20.

As shown in FIGS. 2 and 4 to 6, the display apparatus according to an embodiment of this disclosure may comprise a color filter substrate and an array substrate as well as a liquid crystal layer 70 therebetween. The color filter substrate may further comprise a liquid crystal layer 70 and a first alignment layer 60 located between the liquid crystal layer 70 and RGB color filters (a red color filter R, a green color filter G, and a blue color filter B). The array substrate may comprise an array substrate 90 having a thin-film transistor, a second alignment layer 80 located on a side of the array substrate 90 close to the liquid crystal layer 70, and a polarization layer 100 located on a side of the array substrate 90 away from the liquid crystal layer 70.

As shown in FIG. 3, the opening 400 in the planarization layer 20 is in one-to-one correspondence with the red color filter R. The orthographic projection of the red color cast compensation layer 40 on the base substrate 10 may cover the orthographic projection of the red color filter R on the base substrate 10. The orthographic projections of the first grid region GR1 and two first black matrix lines BM1 and two second black matrix lines BM2 constituting the first grid region GR1 on the base substrate 10 may cover the orthographic projection of the red color cast compensation layer 40 on the base substrate 10. In this disclosure, “cover” may comprise “overlap”. There are a plurality of first grid regions GR1, and therefore there are a plurality of red color filters R. The opening 400 being in one-to-one correspondence with the red color filter R indicates that there is one opening 400 for one red color filter R. The orthographic projection of the opening 400 on the base substrate 10 may cover the orthographic projection of the red color filter R on the base substrate 10.

A plurality of grid regions arranged in a matrix form, which are constituted by staggering a plurality of first black matrix lines BM1 and a plurality of second black matrix lines BM2, may be rectangular or square. Therefore, the shape of the red color filter R may be rectangular or square. The shape of the red color cast compensation layer 40 is not particularly limited, as long as the light passing through the red color filter R can completely pass through the red color cast compensation layer 40. For example, the shapes of the red color cast compensation layer 40 and the red color filter R are the same or geometrically similar. That is, the orthographic projection of the red color cast compensation layer 40 on the base substrate 10 may cover the orthographic projection of the red color filter R on the base substrate 10. However, in view of the costs of the anisotropic photochromic material of the red color cast compensation layer 40, the orthographic projection of the red color cast compensation layer 40 on the base substrate 10 may not cover or be partly overlapped with the orthographic projections of other color filters on the base substrate 10, because this material can be only excited by red light. In an Example according to this disclosure, the orthographic projection of the red color cast compensation layer 40 on the base substrate 10 may be overlapped with the orthographic projection of the red color filter R on the base substrate 10.

The red color cast compensation layer 40 may comprise an anisotropic photochromic material, wherein the part of red light converted to green light or blue light by the anisotropic photochromic material increases as the angle α increases. The anisotropic photochromic material may be selected from the group consisting of diarylethylene, pyrryl fulgide, or a mixture thereof. The thickness of the red color cast compensation layer 40 is not greater than the thickness of the planarization layer 20, and may be, for example 1 mm to 5 mm, for example 1.5 mm to 4.5 mm, or about 2 mm to about 4 mm.

The red color cast compensation layer 40 may be formed by coating and film-forming with a solution of the anisotropic photochromic material and polymethyl methacrylate (PMMA) in cyclohexanone, wherein the concentration of the anisotropic photochromic material may be 0.05 mol/L to 3.0 mol/L. The concentration of PMMA may be determined according to the molecular weight, the dissolution temperature, and the dissolution time of PMMA. In general, excessive PMMA may be added to cyclohexanone for dissolution to form a supersaturated solution. Otherwise, the molar concentration range of PMMA may be 1%to 10%, for example 1.5% to 5%.

Color does not change when red light passes through the red color cast compensation layer 40 at an angle α of zero (i.e., an orthographic view angle). That is, the red color cast compensation layer 40 mainly transmits red light. The proportion of red light which is converted to green light or blue light increases as the angle α increases, until a maximum is obtained when the angle α is close to 90 degrees. When the angle α is close to 90 degrees, the anisotropic chromic material in the red color cast compensation layer 40 has the minimum transmittance for red light. That is, the proportion of red light which is converted to green light or blue light is the largest compared to other angles. From the standpoint of light flux, the red light flux is the largest at an orthographic view angle (α=0 degree), while the red light flux decreases at a side view angle as the angle α increases since red light is converted to green light or blue light. That is, with respect to the orthographic view angle, a part of red light is subjected to blue shift, and this conversion is a process of gradual change. That is, color does not change at an orthographic view angle, while a part of red light is converted to green light or blue light by the anisotropic photochromic material at an angle α of greater than zero (i.e., a side view angle). Therefore, the final effect corresponds to the reduction or elimination of color cast of red light in a direction of a side view angle.

As shown in FIGS. 4 to 6, the openings 401 and 402 in the planarization layer 20 are in one-to-one correspondence with second black matrix lines BM2 adjacent to one color filter selected from the red color filter R, the green color filter G, and the blue color filter B. The orthographic projection of the red color cast compensation layer on the base substrate 10 is covered by the orthographic projection of the second black matrix line BM2, which is adjacent to one color filter selected from the red color filter R, the green color filter G, and the blue color filter B, on the base substrate 10. The red color cast compensation layer 40 is located in the openings 401 and 402 of the planarization layer 20. There are a plurality of first grid regions GR1, a plurality of second grid regions GR2, and a plurality of third grid regions GR3, and therefore there are a plurality of red color filters R, a plurality of green color filters G, and a plurality of blue color filters B. The openings 401 and 402 in the planarization layer 20 being in one-to-one correspondence with second black matrix lines BM2 adjacent to one color filter selected from the red color filter R, the green color filter G, and the blue color filter B indicates that there is one opening 401 or 402 for one second black matrix line BM2 adjacent to one color filter selected from the red color filter R, the green color filter G, and the blue color filter B. The orthographic projection of the second black matrix line BM2 on the base substrate 10 may cover the orthographic projection of the opening 401 or 402 on the base substrate 10.

In view of process fluctuation, the distance between the orthographic projection of the red color cast compensation layer 40 on the base substrate 10 and the orthographic projection of one color filter selected from the red color filter R, the green color filter G, and the blue color filter B on the base substrate 10 is greater than 7 μm.

The red color cast compensation layer 40 may comprise an isotropic photochromic material. The isotropic photochromic material is excited by red light to generate a photochromic effect, and red light is converted to green light or blue light after passing through the isotropic photochromic material. The isotropic photochromic material may be MoO₃.

The red color cast compensation layer 40 may comprise an anisotropic photochromic material. The anisotropic photochromic material may be selected from the group consisting of diarylethylene, pyrryl fulgide, or a mixture thereof. The red color cast compensation layer 40 may be formed by coating and film-forming with a solution of the anisotropic photochromic material and PMMA in cyclohexanone, wherein the concentration of the anisotropic photochromic material may be 0.05 mol/L to 3.0 mol/L. The concentration of PMMA may be determined according to the molecular weight, the dissolution temperature, and the dissolution time of PMMA. In general, excessive PMMA may be added to cyclohexanone for dissolution to form a supersaturated solution. Otherwise, the molar concentration range of PMMA may be 1%to 10%, for example 1.5% to 5%.

Red light does not pass through the red color cast compensation layer 40 at an angle α of zero (i.e., an orthographic view angle). Red light passes through the red color cast compensation layer 40 and the proportion of red light which is converted to green light or blue light increases as the angle α increases, until a maximum is obtained when the angle α is close to 90 degrees. When the angle α is close to 90 degrees, the anisotropic chromic material in the red color cast compensation layer 40 has the minimum transmittance for red light. That is, the proportion of red light which is converted to green light or blue light is the largest compared to other angles. From the standpoint of light flux, the red light flux is the largest at an orthographic view angle (α=0 degree), while the red light flux decreases at a side view angle as the angle α increases since red light is converted to green light or blue light. That is, with respect to the orthographic view angle, a part of red light is subjected to blue shift, and this conversion is a process of gradual change. That is, color does not change at an orthographic view angle, while a part of red light is converted to green light or blue light by the anisotropic photochromic material at an angle α of greater than zero (i.e., a side view angle). Therefore, the final effect corresponds to the reduction or elimination of color cast of red light in a direction of a side view angle.

The depth of the opening may be 1 mm to 5 mm, for example 1.5 mm to 4.5 mm, or 2 mm to 4 mm. Since the thickness of a red color filter layer is on a micron scale, the depth of the opening is much larger than that of the red color filter layer and red light at a relatively small angle a may be allowed to pass through the red color cast compensation layer 40 in the opening for photochromism. If the depth of the opening is relatively small, it means that light beams at a relatively large angle α can pass through a photochromic material for color compensation.

As shown in FIG. 4, the red color cast compensation layer 40 may be located in the opening of the planarization layer 20. The opening is in one-to-one correspondence with the second black matrix line BM2 adjacent to the green color filter G. The orthographic projection of the red color cast compensation layer on the base substrate 10 is covered by the orthographic projection of the second black matrix line BM2, adjacent to the green color filter G, on the base substrate 10.

The opening may comprise a first opening 401 in one-to-one correspondence with the second black matrix line BM2 between the green color filter G and the red color filter R, and a second opening 402 in one-to-one correspondence with the second black matrix line BM2 between the green color filter G and the blue color filter B.

The first opening 401 and the second opening 402 should be as close to the red color filter R as possible so as to allow red light at a relatively small angle α to pass through the red color cast compensation layer 40 in the first opening 401 and the second opening 402 for photochromism. However, in view of process fluctuation, the distance between the orthographic projection of the first opening 401 on the base substrate 10 and the orthographic projection of the red color filter R on the base substrate 10 may be greater than 7 μm, for example 7.5 μm to 20 μm, for example about 8 μm to about 16 μm. The distance between the orthographic projection of the second opening 402 on the base substrate 10 and the orthographic projection of the blue color filter B on the base substrate 10 is greater than about 7 μm, for example about 7.5 μm to about 20 μm, for example about 8 μm to about 16 μm.

The lengths of the first opening 401 and the second opening 402 along a row direction are greater than or equal to the length of the red color filter R along a row direction so as to allow red light at an angle α may at least partly or completely pass through the red color cast compensation layer 40 in the first opening 401 and the second opening 402 for photochromism.

As shown in FIG. 5, the red color cast compensation layer 40 may be located in the opening of the planarization layer 20. The opening is in one-to-one correspondence with the second black matrix line BM2 adjacent to the blue color filter B. The orthographic projection of the red color cast compensation layer on the base substrate 10 is covered by the orthographic projection of the second black matrix line BM2, adjacent to the blue color filter B, on the base substrate 10.

The opening may comprise a first opening 401 in one-to-one correspondence with the second black matrix line BM2 between the blue color filter B and the green color filter G, and a second opening 402 in one-to-one correspondence with the second black matrix line BM2 between the blue color filter B and the red color filter R.

The first opening 401 and the second opening 402 should be as close to the red color filter R as possible so as to allow red light at a relatively small angle α to pass through the red color cast compensation layer 40 in the first opening 401 and the second opening 402 for photochromism. However, in view of process fluctuation, the distance between the orthographic projection of the first opening 401 on the base substrate 10 and the orthographic projection of the green color filter G on the base substrate 10 may be greater than 7 μm, for example 7 μm to 20 μm, for example 8 μm to 16 μm. the distance between the orthographic projection of the second opening 402 on the base substrate 10 and the orthographic projection of the red color filter R on the base substrate 10 may be greater than 7 μm, for example 7.5 μm to 20 μm, for example 8 μm to 16 μm.

The lengths of the first opening 401 and the second opening 402 along a row direction are greater than or equal to the length of the red color filter R along a row direction so as to allow red light at an angle α may at least partly or completely pass through the red color cast compensation layer 40 in the first opening 401 and the second opening 402 for photochromism.

As shown in FIG. 6, the red color cast compensation layer 40 may be located in the opening of the planarization layer 20. The opening is in one-to-one correspondence with the second black matrix line BM2 adjacent to the red color filter R. The orthographic projection of the red color cast compensation layer on the base substrate 10 is covered by the orthographic projection of the second black matrix line BM2, adjacent to the red color filter R, on the base substrate 10.

The opening may comprise a first opening 401 in one-to-one correspondence with the second black matrix line BM2 between the red color filter R and the blue color filter B, and a second opening 402 in one-to-one correspondence with the second black matrix line BM2 between the red color filter R and the green color filter G.

The first opening 401 and the second opening 402 should be as close to the red color filter R as possible so as to allow red light at a relatively small angle α to pass through the red color cast compensation layer 40 in the first opening 401 and the second opening 402 for photochromism. However, in view of process fluctuation, the distance between the orthographic projection of the first opening 401 on the base substrate 10 and the orthographic projection of the red color filter R on the base substrate 10 may be greater than 7 μm, for example 7.5 μm to 20 μm, for example 8 μm to 16 μm. the distance between the orthographic projection of the second opening 402 on the base substrate 10 and the orthographic projection of the red color filter R on the base substrate 10 may be greater than 7 μm, for example 7.5 μm to 20 μm, for example 8 μm to 16 μm.

The lengths of the first opening 401 and the second opening 402 along a row direction are greater than or equal to the length of the red color filter R along a row direction so as to allow red light at an angle α may at least partly or completely pass through the red color cast compensation layer 40 in the first opening 401 and the second opening 402 for photochromism.

The opening in the planarization layer 20 as shown in FIGS. 4 to 6 may be a wedge opening. It is to be noted that the wedge opening actually has a bottom side at the side of the base substrate 10 and an opening side at the side of the RGB color filter according to process steps in FIGS. 4 to 6. In other words, the opening side of the wedge opening faces toward the second black matrix line. The width of the bottom of the wedge opening may be 10 μm or more, for example 10 μm to 30 μm, for example 12 μm to 24 μm. The width of the opening of the wedge opening is 15 μm or more, for example 20 μm to 50 μm, for example 25 μm to 40 μm. The width of the bottom of the wedge opening is less than that of the opening of the wedge opening. Assuming that the distance between the edge of the red color filter R and the red color cast compensation layer 40 is y and the height of the wedge opening is x, the view angle of color change is arctan(y/x).

The production of the wedge opening may be performed by isotropic etching, which means that etching rates are the same in all directions, wherein all of wet etching and apart of dry etching are isotropic, or anisotropic etching, which means that etching is in one direction, inner walls after etching are substantially perpendicular, and only dry etching is performed for anisotropy.

The thickness of the first insulating layer 50 may be 0.4 μm to 1.0 μm, for example 0.5 μm to 0.9 μm, for example 0.6 μm to 0.8 μm. The material of the first insulating layer 50 may comprise a silicon nitride (SiNₓ). The first insulating layer 50 may be used to prevent the reaction between the red color filter R and the red color cast compensation layer 40.

The thickness of the planarization layer 20 may be 1 mm to 5 mm, for example 1.5 mm to 4.5 mm, or 2 mm to 4 mm. The material of the planarization layer 20 may comprise polyimide and acrylic.

The thickness of the second insulating layer 30 may be 0.4 μm to 1.0 μm, for example 0.5 μm to 0.9 μm, for example 0.6 m to 0.8 μm. The material of the second insulating layer 30 may comprise a silicon nitride (SiNₓ). The second insulating layer 30 may be used to prevent the reaction between the red color cast compensation layer 40 and the base substrate such as a glass substrate.

In another aspect of this disclosure, there may be provided a display apparatus, comprising the color filter substrate according to any one described above.

This display apparatus may comprise a display panel. This display apparatus may be a liquid crystal display apparatus, and may be a product or member with any display function, such as a liquid crystal display, a liquid crystal television, a digital photo frame, a cell phone, a tablet computer, a digital photo frame, and the like.

By using the color filter substrate and the display apparatus of this disclosure, the red color cast compensation layer 40 is located between the base substrate 10 and the red color filter R, wherein red light passes through the red color filter R in a direction deviating from the vertical direction of the base substrate 10 at an angle α and the red color cast compensation layer 40 at least partly converts red light passing through the red color filter R to green light or blue light, wherein the wavelength of red light is longer than that of green light and wavelength of green light is longer than that of blue light, and wherein the angle α is greater than or equal to 0 degree and less than 90 degrees. Therefore, red color cast at left and right view angles may be reduced. Red light passing through the red color filter R in a direction deviating from the vertical direction of the base substrate 10 at an angle α may be generated due to diffuse reflection.

With respect to the display apparatus according to this disclosure, the brightness of blue light increases and the brightness of red light and the brightness of green light relatively decrease in a bright state, while it may be regarded as a process wherein the contrast of blue light increases compared to red light and green light in the case where the brightness does not change in a dark state. the contrast of blue light may be 1.1 times to 5 times the contrasts of red light and green light, for example 1.2 times to 4.5 times, or 1.5 times to 4.0 times.

As an example, a production method for the display apparatus as shown in FIG. 2 is provided below.

Firstly, an acrylic planarization layer 20 is coated on a glass substrate (i.e., a base substrate 10), such that the thickness thereof is 2.0 mm after drying.

Secondly, the acrylic planarization layer 20 is patterned by etching to form an opening for forming a red color cast compensation layer 40 in a position corresponding to a red color filter R, such that the size of the opening is equal to that of the red color filter R after a SiNₓ layer is deposited.

Then, a SiNₓ layer (i.e., a second insulating layer 30) having a thickness of 0.6 μm is formed by chemical vapor deposition of silane and nitrogen on the patterned acrylic planarization layer 20 and in the opening.

Then, a solution of pyrryl fulgide and PMMA in cyclohexanone is coated in the opening with the SiNₓ layer deposited and then dried, and coating and drying are repeated several times to form an anisotropic photochromic layer (i.e., a red color cast compensation layer 40), which is flush with the planarization layer, in the opening of the planarization layer. The concentration of pyrryl fulgide is 0.5 mol/L, and the concentration of PMMA is the saturated concentration of PMMA in cyclohexanone.

Then, a SiNₓ layer (i.e., a first insulating layer 50) having a thickness of 0.6 μm is formed by chemical vapor deposition of silane and nitrogen on the acrylic planarization layer with the anisotropic photochromic layer deposited.

Thereafter, a black matrix BM, a red color filter R, a green color filter G, and a blue color filter B are formed on a polyimide layer, such that the red color filter R is located directly above the anisotropic chromic layer 40, i.e., the orthographic projection of the red color filter R on the base substrate 10 is overlapped with the orthographic projection of the anisotropic chromic layer 40 on the base substrate 10.

Then, it is cell-aligned with a thin-film transistor. FIG. 2 is a schematic diagram of a display apparatus after cell-aligning.

As shown in FIG. 2, the display apparatus after cell-aligning further comprises a first alignment layer 60 in contact with the black matrix, a liquid crystal layer 70, a second alignment layer 80, an array substrate 90 having a thin-film transistor, and a polarization layer 100, in this order. Since light beams emitted by backlight are mainly direct light, and this part of polarized light corresponds to the excitation performed on the anisotropic chromic layer, which leads to the generation of photoinduced anisotropy.

With respect to the display apparatus produced as described above, the brightness of blue light increases and the brightness of red light and the brightness of green light relatively decrease in a bright state, while it may be regarded as a process wherein the contrast of blue light increases compared to red light and green light in the case where the brightness does not change in a dark state. The contrast of blue light is 2.0 times the contrasts of red light and green light.

Chromaticity simulation is performed in the case where RGB contrasts are the same and in the case where the B contrast is twice the RG contrasts. Results are summarized in Table 1 and Table 2.

Results of chromaticity simulation are simulated by using Techwiz 2D software, wherein θ aφ each represent a view angle, θ represents an included angle (degrees) perpendicular to the plan of the substrate, and φ represents an angle (degrees) in the plan of the substrate. Here, u and v each represent a chromatic value in the CIE1976 colorimetric system in chromaticity, and Δu and Δv represent the magnitude of the chromatic deviation of the white-point chromaticity coordinates at different view angles, respectively.

TABLE 1

| | | RGB with the same | | | |
|---|---|---|---|---|---|
| | | contrast_φ 30 | | | |
| θ | φ | u | v | Δu | Δv |
| 0 | 30 | 0.188378 | 0.390246 | 0 | 0.390246 |
| 15 | 30 | 0.192253 | 0.418489 | 0.005155 | 0.418489 |
| 30 | 30 | 0.19465 | 0.451058 | 0.009252 | 0.451058 |
| 45 | 30 | 0.193655 | 0.454287 | 0.007164 | 0.454287 |
| 60 | 30 | 0.192427 | 0.453848 | 0.005543 | 0.453848 |
| 0 | 150 | 0.188378 | | | |
| 15 | 150 | 0.187098 | | | |
| 30 | 150 | 0.185398 | | | |
| 45 | 150 | 0.186491 | | | |
| 60 | 150 | 0.186883 | | | |

TABLE 2

| | | Contrast of B being twice of | | | |
|---|---|---|---|---|---|
| | | contrasts of R/G_φ30 | | | |
| θ | φ | u | v | Δu | Δv |
| 0 | 30 | 0.189703654 | 0.314719212 | 0 | 0 |
| 15 | 30 | 0.191490985 | 0.346781019 | 0.002650351 | 0.03286834 |
| 30 | 30 | 0.191782647 | 0.387263918 | 0.005147231 | 0.061628425 |
| 45 | 30 | 0.191114206 | 0.390806033 | 0.004006764 | 0.051398595 |
| 60 | 30 | 0.190564003 | 0.389376639 | 0.002934977 | 0.044704373 |
| 0 | 150 | 0.189703654 | 0.314719212 | | |
| 15 | 150 | 0.188840634 | 0.313912679 | | |
| 30 | 150 | 0.186635416 | 0.325635493 | | |
| 45 | 150 | 0.187107443 | 0.339407438 | | |
| 60 | 150 | 0.187629026 | 0.344672266 | | |

Data in the Tables demonstrate the comparison of white-point chromaticity coordinates before and after the contrast of blue light becomes twice those of red light and green light. As can be seen from the comparisons of Table 1 and Table 2, Δu and Δv in Table 1 are greater than those in Table 2 at different view angles, indicating that the case of chromaticity deviation at different view angles is that the color cast in Table 2 is smaller.

As can be seen from Table 1 and Table 2, the color cast at left and right view angles shifts to the direction blue light after a photochromic thin film is added. Since the stimulation of blue light for human eyes is relatively small, the stimulation of color cast for human has been improved.

According to one embodiment of this disclosure, under the condition that the gamut standard is satisfied, the materials of the red color filter, the green color filter, and the blue color filter used in the liquid crystal panel remain unchanged. The transmission spectrum of the blue color filter may be changed by using an anisotropic photochromic material. This corresponds to the case that a part of red/ultraviolet spectra are converted to another color, and corresponds to the case that the transmittances of a part of red/ultraviolet wavebands are reduced and the transmittances of other corresponding wavebands are increased. With respect to MoO₃, red light/ultraviolet light is converted to blue wavebands; and with respect to diarylethylene-based chromic compounds or pyrryl fulgide, red light is converted to blue light.

According to another embodiment of this disclosure, images of twisted nematic (TN) mode display at left and right view angles are typically reddish in a bright state, a photoinduced anisotropic thin film is coated on the back side of the red color filter (as shown in FIG. 2) or an anisotropic material layer is formed in the opening obliquely above one of the three color filters (as shown in FIGS. 4 to 5), and the ring-closing reaction the anisotropic photochromic material in the thin film is excited by red light generated by the red color filter at left or right side of the blue color filter or the green color filter to perform ring-closing reaction. At this time, the absorption peak is at red light, and therefore red light at high angles can be reduced. At this time, the color cast at left and right view angles is improved. In the case of the isotropic material such as MoO₃ as shown in FIGS. 4 to 5, red light/ultraviolet light is converted to blue wavebands. In this way, the problem of color cast at left and right view angles in a bright state may be improved, and it is suitable for use in a circumstance having a relatively high requirement for color cast at left and right view angles in a bright state.

Obviously, various modifications and variations may be made to the Examples of this disclosure by the person skilled in the art without deviating from the spirit and the scope of this disclosure. Thus, if these modifications and variations of this disclosure are within the scope of the claims of this disclosure and equivalent techniques thereof, this disclosure also intends to encompass these modifications and variations.

1. A color filter substrate, comprising:
a base substrate,
a black matrix, which comprises a plurality of first black matrix lines along a first direction and a plurality of second black matrix lines along a second direction, wherein the plurality of first black matrix lines and the plurality of second black matrix lines are staggered to constitute a plurality of grid regions arranged in a matrix form, and wherein the plurality of grid regions comprise at least a first grid region, and wherein the first direction and the second direction are different;
a first color filter, which is located in the first grid region;
a planarization layer, which is located between the base substrate and the black matrix and has an opening; and
a first color cast compensation layer, which is located in the opening of the planarization layer, and configured such that in response to a light of a first color passing through the first color filter in a direction deviating from the vertical direction of the base substrate at an angle α, the first color cast compensation layer at least partly converts the light of the first color passing through the first color filter into a light of a second color or a light of a third color, wherein the light of the first color has a wavelength longer than that of the light of the second color, the light of the second color has a wavelength longer than that of the light of the third color, and the angle α is greater than or equal to 0 degree and less than 90 degrees.

2. The color filter substrate according to claim 1, wherein
the opening is in one-to-one correspondence with the first color filter;
an orthographic projection of the first color cast compensation layer on the base substrate covers an orthographic projection of the first color filter on the base substrate; and
orthographic projections of the first grid region and two first black matrix lines and two second black matrix lines constituting the first grid region on the base substrate cover an orthographic projection of the first color cast compensation layer on the base substrate.

3. The color filter substrate according to claim 1, wherein the first color cast compensation layer has a thickness of 1 mm to 5 mm.

4. The color filter substrate according to claim 1, further comprising a second color filter and a third color filter, wherein
the plurality of grid regions further comprise a second grid region and a third grid region, and the second color filter is located in the second grid region and the third color filter is located in the third grid region; and
the opening is in one-to-one correspondence with the second black matrix line adjacent to one color filter selected from the first color filter, the second color filter, and the third color filter, and an orthographic projection of the first color cast compensation layer on the base substrate is covered by an orthographic projection of the second black matrix line, which is adjacent to one color filter selected from the first color filter, the second color filter, and the third color filter, on the base substrate.

5. The color filter substrate according to claim 4, wherein the first color cast compensation layer comprises an isotropic photochromic material, wherein the isotropic photochromic material is excited by a light of a first color to generate a photochromic effect, and the light of the first color is converted to a light of a second color or a light of a third color after passing through the isotropic photochromic material.

6. The color filter substrate according to claim 5, wherein the isotropic photochromic material comprises MoO₃.

7. The color filter substrate according to claim 2, wherein the first color cast compensation layer comprises an anisotropic photochromic material, wherein the light of the second color or the light of the third color converted from the light of the first color by the anisotropic photochromic material increases as the angle α increases.

8. The color filter substrate according to claim 7, wherein the anisotropic photochromic material is selected from the group consisting of diarylethylene, pyrryl fulgide, or a mixture thereof.

9. The color filter substrate according to claim 4, wherein the distance between an orthographic projection of the first color cast compensation layer on the base substrate and an orthographic projection of one color filter selected from the first color filter, the second color filter, and the third color filter on the base substrate is greater than 7 μm.

10. The color filter substrate according to claim 4, wherein a length of the opening along the second direction is greater than or equal to a length of the first color filter along the second direction.

11. The color filter substrate according to claim 4, wherein the opening is a wedge opening toward the second black matrix line, and the wedge opening has a bottom width of 10 μm or more and an opening width of 15 μm or more.

12. The color filter substrate according to claim 1, further comprising a first insulating layer located between the first color filter and the first color cast compensation layer, wherein the first insulating layer has a thickness of 0.4 μm to 1.0 μm.

13. The color filter substrate according to claim 1, wherein the planarization layer has a thickness of 1 mm to 5 mm.

14. The color filter substrate according to claim 1, further comprising a second insulating layer located between the base substrate and the first color cast compensation layer, wherein the second insulating layer has a thickness of 0.4 μm to 1.0 μm.

15. A display apparatus, comprising the color filter substrate according to claim 1.

16. The color filter substrate according to claim 4, wherein the first color case compensation layer comprises an anisotropic photochromic material, wherein the light of the second color or the light of the third color converted from the light of the first color by the anisotropic photochromic material increases as the angle α increases.

17. The color filter substrate according to claim 16, wherein the anisotropic photochromic material is selected from the group consisting of diarylethylene, pyrryl fulgide, or a mixture thereof.
